(19) United States
(12) Patent Application Publication
(10) Pub. No.: US 2026/0342857 A1
(43) Pub. Date: Oct. 29, 2026

(54) API GATEWAY - END TO END AUTOMATED SECURE ACCESS AND POLICY ENFORCEMENT

(71) Applicant: Interwise Ltd., Ben-Gurion Airport (IL)

(72) Inventors: Nir Ganani, Hod Hasharon (IL); Lital Mason, Ganei Yohanan (IL); Nir Cohen, Bet Dagan (IL); Meni Sasson, Kochav Yair (IL)

(73) Assignee: Interwise Ltd., Ben-Gurion Airport (IL)

(21) Appl. No.: 19/192,585

(22) Filed: Apr. 29, 2025

(51) Int. Cl. H04L 9/40

(52) U.S. Cl. CPC H04L 63/20; H04L 63/0807; H04L 63/10

(57) ABSTRACT

Aspects of the subject disclosure may include, for example, an API gateway and system that receives an API definition and security policy from a provider, registers the API with an identity management system, and generates a token-based authentication and authorization policy. It involves receiving a client registration request, registering the consumer with the identity management system, providing client credentials, validating them, and enforcing access control based on validated credentials, ensuring secure API interactions. Other embodiments are disclosed.

### FIELD OF THE DISCLOSURE

The subject disclosure relates to Application Programming Interface (API) access management and policy enforcement systems.

### BACKGROUND

In today's digital landscape, communication systems and cloud infrastructures increasingly rely on interfaces for delivering and consuming services, which demand scalability, efficiency, and robust security. Access control and identity management play a significant role in facilitating reliable service function and minimizing vulnerabilities. Organizations utilize these frameworks for secure data exchange and operational continuity, highlighting the importance of effective access management. Digital systems are designed to streamline integration for providers and consumers, aiming to simplify service exposure while enforcing security measures against unauthorized access.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of an API provider registration flow in accordance with various aspects described herein.

FIG. 2B is a block diagram illustrating an example, non-limiting embodiment of an API consumer registration flow in accordance with various aspects described herein.

FIG. 2C is a block diagram illustrating an example, non-limiting embodiment of an API consumer runtime flow in accordance with various aspects described herein.

FIGS. 2D-2F depict illustrative embodiments of methods in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for an automated system that manages API access and policy enforcement, integrating authentication and authorization processes with identity management to streamline service exposure and secure data exchange between API providers and consumers. Other embodiments are described in the subject disclosure.

In various embodiments, the management of API access between an API service provider and an API consumer is streamlined through automated creation of authentication and authorization policies, along with integration with Trusted Identity Management (IdM), to enhance security, efficiency, and scalability.

In one embodiment, upon the creation of an API by the service provider, authentication and authorization policies are automatically generated. These policies define the rules that govern access to the API, eliminating the need for manual policy creation and updates. This automation reduces the potential for human error and significantly speeds up the deployment process, addressing the time-consuming and error-prone nature of previous manual configurations.

Another embodiment involves seamless integration with Trusted Identity Management (IdM). Provider applications are created with claim values, and client applications for API consumers are managed through Dynamic Client Registration (DCR). This integration ensures robust and standardized authentication and authorization protocols, enhancing security compared to previous methods that relied on less secure and inconsistent mechanisms.

Embodiments also streamline API discovery and ordering, allowing API consumers to discover and test APIs via various API stores. The ordering system verifies the consumer's billing account and processes access requests, simplifying API discovery and access. This provides a more user-friendly experience compared to earlier methods that involved cumbersome manual workflows for access requests and approvals.

In further embodiments, access approval and role assignment are automated. Once an API access request is approved, either manually by the provider or automatically, the consumer's client application is assigned a role within the provider application based on the approved access level. This automation reduces delays and ensures consistent application of access controls, addressing the inconsistencies and slower response times of previous manual approaches.

Finally, embodiments ensure secure API usage with policy enforcement. When the API consumer attempts to use the API, the authentication and authorization policy is checked to ensure the client application has the correct role and permissions. This automated policy enforcement ensures that only authorized clients can access the API, enhancing security and reducing the risk of unauthorized access, which was a vulnerability in earlier methods lacking automated enforcement.

One or more aspects of the subject disclosure include a device, comprising a processing system including a processor and a memory that stores executable instructions that, when executed by the processing system, facilitate performance of operations. The operations may include receiving an API definition and a corresponding security policy from an API provider; creating an API within an API gateway based on the received API definition; generating a policy for the API that combines authentication and authorization based on the received security policy; registering the API provider application with an identity management system; receiving an application ID from the identity management system in response to the registration; updating the policy for the API with the application ID; and storing the updated policy within the API gateway to facilitate secure access and management of the API.

Additional aspects of the subject disclosure may include automatically generating a JSON Web Token (JWT) as part of the authentication and authorization policy for the API, enhancing security by encapsulating authentication and authorization information in a single token. The identity management system may be integrated with Azure Active Directory (AAD) to facilitate the management of user identities and roles, providing a robust framework for identity management and access control. The operations may further comprise providing an option for the API provider to manually approve or automatically approve API consumer access requests, offering flexibility in access control management. Rate limiting and monitoring of API usage may be implemented to prevent unauthorized access and ensure compliance with the security policy, thereby maintaining the integrity and security of the API. Additionally, access permissions may be dynamically adjusted based on predefined rules and usage patterns, allowing for adaptive security measures that respond to changing conditions and user behaviors.

One or more aspects of the subject disclosure include a method, comprising: receiving, by a processing system including a processor, a definition for an application programming interface (API) and a corresponding security policy from an API provider; registering, by the processing system, the definition for the API with an identity management system; receiving, by the processing system, a registration response from the identity management system; generating, by the processing system, a token-based authentication and authorization policy in response to the definition for the API, the security policy, and the registration response; receiving, by the processing system, a client registration request from an API consumer, wherein the client registration request requests access to the API; registering, by the processing system, the API consumer with the identity management system; receiving, by the processing system, client credentials from the identity management system; providing, by the processing system, the client credentials to the API consumer; receiving, by the processing system, an access request from the API consumer including the client credentials; validating, by the processing system, the client credentials received from the API consumer to create validated credentials; and enforcing, by the processing system, access control for the API based on the validated credentials.

Additional aspects of the subject disclosure may include the use of a token-based authentication and authorization policy that incorporates a JSON Web Token (JWT), encapsulating authentication and authorization information for the API consumer in a secure and efficient manner. The processing system may assign a default role to the API consumer upon registration with the identity management system, streamlining the initial access setup. Client credentials, including a client ID and a client secret, are utilized to authenticate the API consumer, ensuring secure access to the API. The security policy may be updated by the processing system based on predefined rules and usage patterns, allowing for dynamic adjustment of access permissions to adapt to changing conditions. Integration with Azure Active Directory (AAD) facilitates the management of user identities and roles, providing a robust framework for identity management. The processing system may offer the API provider an option to automatically approve access requests, enhancing flexibility in access control management. Enforcing access control may include rate limiting and monitoring of API usage to prevent unauthorized access and ensure compliance with the security policy, thereby maintaining the integrity and security of the API.

One or more aspects of the subject disclosure include a non-transitory machine-readable medium, comprising executable instructions that, when executed by a processing system including a processor, facilitate performance of operations. The operations may include receiving a client registration request from an API consumer, the client registration request requesting access to an API; registering the API consumer with an identity management system; receiving client credentials from the identity management system; providing the client credentials to the API consumer; receiving an access request from the API consumer including the client credentials; validating the client credentials received from the API consumer to create validated credentials; and enforcing access control for the API based on the validated credentials.

Additional aspects of the subject disclosure may include generating a token for the API consumer upon successful validation of the client credentials, with the token being used for subsequent access requests to streamline the authentication process. The operations may further comprise renewing the token for the API consumer at predefined intervals to maintain continuous access and enhance security. Additionally, the operations may involve validating the token received from the API consumer during runtime to ensure its authenticity and integrity before granting access to the requested resources. The API consumer may be provided with a default role upon registration, which determines their level of access to the API, thereby simplifying the initial setup and ensuring appropriate access controls. Furthermore, access permissions of the API consumer may be dynamically adjusted based on usage patterns and predefined security policies, allowing for adaptive security measures that respond to changing conditions and user behaviors.

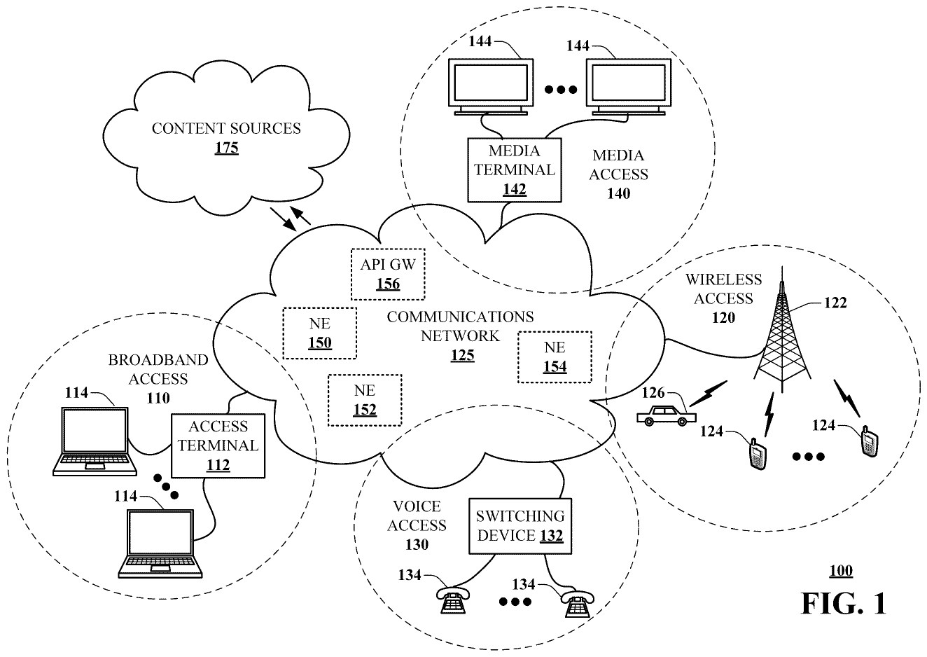

Referring now to FIG. 1, a block diagram is shown illustrating an example, non-limiting embodiment of a system 100 in accordance with various aspects described herein. For example, system 100 can facilitate in whole or in part an automated system that manages API access and policy enforcement, integrating authentication and authorization processes with identity management to streamline service exposure and secure data exchange between API providers and consumers. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

FIG. 1 also shows API Gateway 156. API Gateway 156 serves as a node within the communications network, facilitating the management and routing of API requests across various access channels, including broadband, wireless, voice, and media access. Positioned either inside or outside the network infrastructure, the API Gateway 156 interfaces with multiple network elements, such as routers, switches, and firewalls, to enforce security policies and manage data flow. This integration ensures that API requests are efficiently processed and securely transmitted, providing a scalable environment for API operations.

In some embodiments, the API Gateway 156 acts as an intermediary that handles requests and applies security measures, thereby enhancing the network's ability to deliver diverse services to a wide range of client devices. For example, it may be responsible for registering API providers and consumers, ensuring that applications are securely integrated into the identity management framework. During the provider registration flow, the API Gateway facilitates the creation of APIs and the application of security policies, ensuring that provider applications are registered and managed effectively. In the consumer registration flow, the gateway handles client registration requests, authenticates credentials, and assigns roles, streamlining the onboarding process for API consumers.

Furthermore, the API Gateway 156 handles runtime requests, where it enforces access control policies, validates tokens, and monitors API usage. This ensures that only authorized clients can access the APIs and that security measures are consistently applied. By coordinating with other components in the network, the API Gateway 156 supports seamless communication and robust security, contributing to the efficient operation of the system as a whole. Through its comprehensive management capabilities, the API Gateway 156 enhances security and operational efficiency, providing a centralized platform for routing requests and enforcing policies across various network flows.

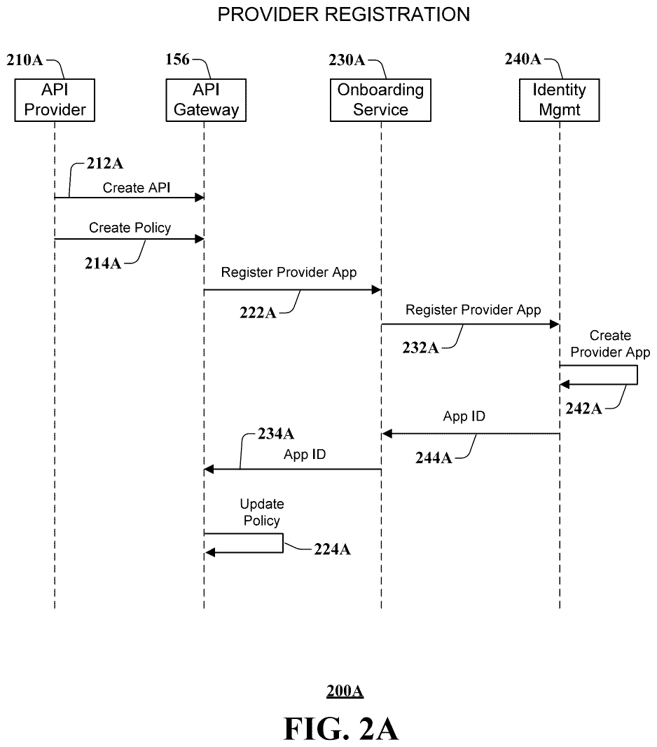

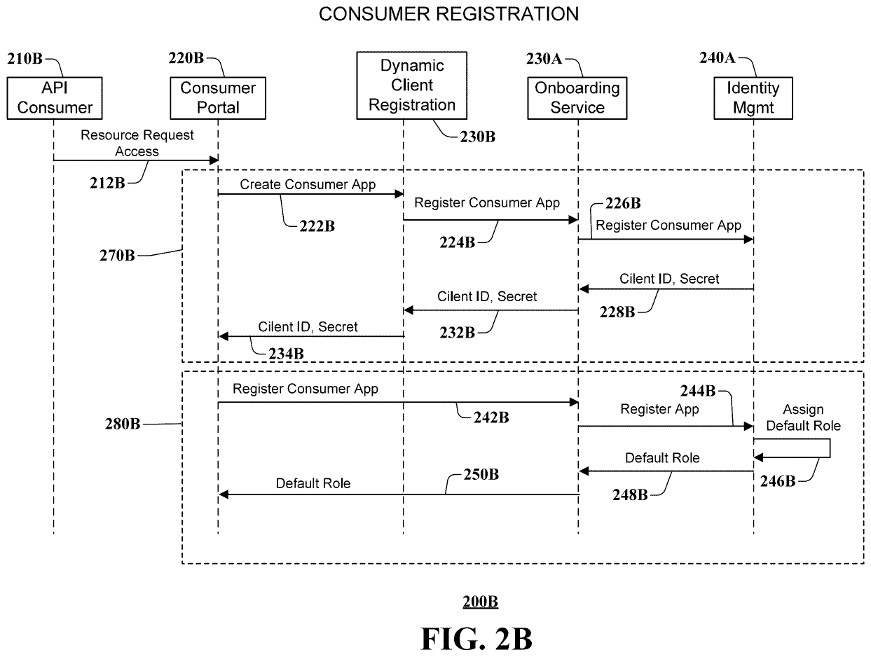

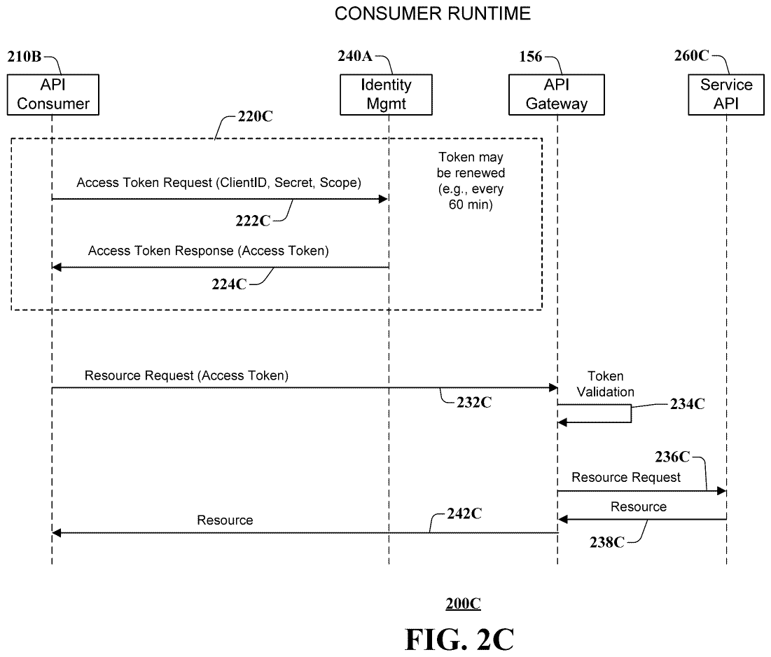

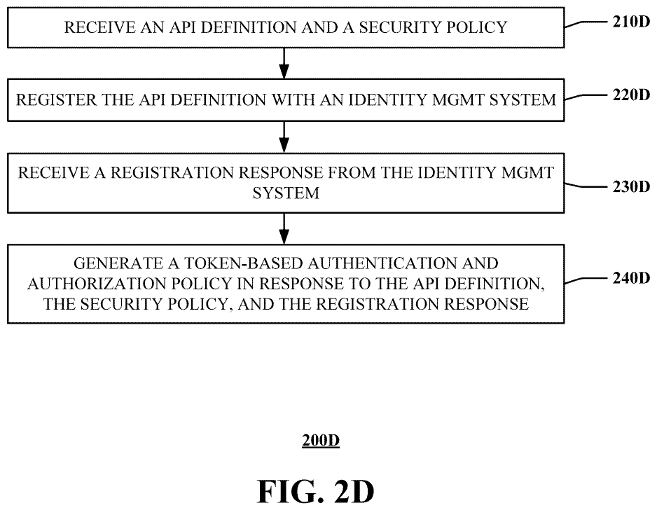

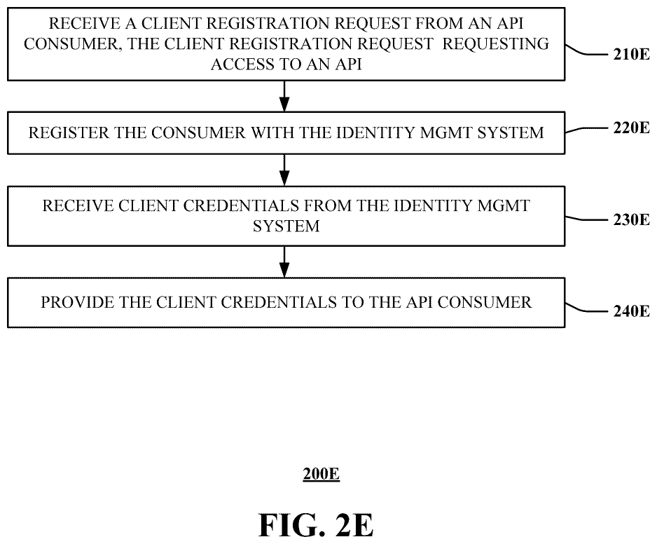

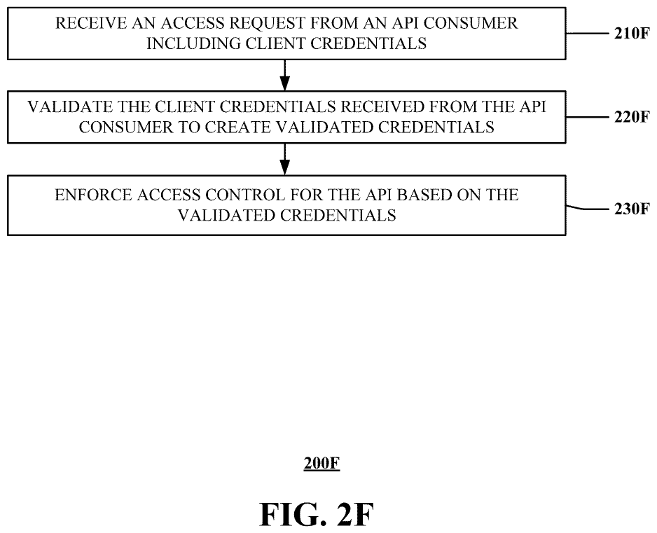

FIG. 2A is a block diagram illustrating an example, non-limiting embodiment of an API provider registration flow in accordance with various aspects described herein. FIG. 2A illustrates interactions between various systems during a provider registration process. For example, interactions are shown between API Provider 210A, API Gateway 156, Onboarding Service 230A, and Identity Management 240A. The flow diagram shows the interactions and communications between these components during the registration process.

The API Provider 210A is responsible for initiating the creation of an API and its associated policy. In some embodiments, the API Provider may be a software application or a user interface that allows a service provider to define API parameters. For example, the API Provider might be implemented as a web-based portal where providers can input API details.

In some embodiments, the API Provider may be an entity such as a telecommunications company, a cloud service provider, or a software development firm. These entities often have the infrastructure and expertise to offer APIs that facilitate various services. For example, a telecommunications company might act as an API Provider by offering an SMS API that allows developers to integrate text messaging capabilities into their applications. This SMS API Provider would define parameters such as message format, delivery options, and security protocols, enabling seamless communication between applications and mobile networks.

In the case of an SMS API Provider, the entity might offer services that allow businesses to send automated text notifications, marketing messages, or alerts to customers. The provider would ensure that the API is capable of handling large volumes of messages, supports various message types, and complies with industry standards for security and privacy. By offering such an API, the provider enables businesses to enhance their communication strategies and improve customer engagement through efficient and reliable text messaging services.

It should be noted that the SMS API is just one example, and the various embodiments are not so limited. Other possible APIs include payment processing APIs, which facilitate secure financial transactions; geolocation APIs, which provide location-based services; and social media APIs, which enable integration with social networking platforms. These examples illustrate the diverse range of services that can be offered through APIs, each tailored to meet specific business needs and technological requirements.

The API Gateway 156 acts as an intermediary that facilitates the creation and management of APIs. In some embodiments, the API Gateway may handle requests and enforce policies. For example, it might be implemented as a cloud-based service that routes API requests and applies security measures.

In the context of the communications network shown in FIG. 1, the API Gateway 156 may serve as a node within the network infrastructure, interfacing with various network elements to manage API traffic. It can be positioned to handle broadband access, wireless access, voice access, and media access, ensuring that API requests are efficiently routed and processed across different communication channels. The gateway may also integrate with network elements such as routers, switches, and firewalls to enforce security policies and manage data flow, providing a secure and scalable environment for API operations.

The API Gateway 156 may be utilized in various flows depicted in the figures, such as the provider registration flow in FIG. 2A, the consumer registration flow in FIG. 2B, and the consumer runtime flow in FIG. 2C. In the provider registration flow, the API gateway facilitates the creation of APIs and the application of security policies, ensuring that provider applications are registered and managed effectively. During the consumer registration flow, the API gateway handles client registration requests, authenticates credentials, and assigns roles, streamlining the onboarding process for API consumers. In the consumer runtime flow, the API gateway enforces access control policies, validates tokens, and monitors API usage, ensuring that only authorized clients can access the APIs and that security measures are consistently applied.

Accordingly, in various embodiments, the API Gateway 156 plays a role in managing API interactions within the communications network, providing a centralized platform for routing requests, enforcing policies, and ensuring secure and efficient API operations across various network flows.

The Onboarding Service 230A manages the registration of the provider application with the identity management system. In some embodiments, the Onboarding Service may automate the registration process. For example, it could be a microservice that interfaces with identity management systems to register applications.

A microservice is a small, independent service that performs a specific function within a larger system. It is designed to be modular, allowing for easy deployment, scaling, and maintenance. Microservices communicate with each other through well-defined APIs, enabling them to work together seamlessly while remaining independently deployable. This architecture allows for greater flexibility and resilience, as each microservice can be developed, tested, and deployed independently.

In the context of the Onboarding Service 230A, a microservice might be responsible for handling the specific task of registering provider applications with an identity management system. For example, it could automate the process of creating application entries, assigning necessary permissions, and generating application IDs. This microservice could be implemented using lightweight frameworks such as Spring Boot or Node.js, which are well-suited for building scalable and efficient microservices. It might be deployed within a cloud environment like AWS Lambda or Azure Functions, allowing for serverless execution and automatic scaling based on demand.

Examples of microservices in other contexts include a payment processing microservice that handles transactions in an e-commerce platform, a notification microservice that sends alerts to users, and a logging microservice that collects and stores application logs for monitoring and analysis. Each of these microservices performs a distinct function, contributing to the overall functionality and robustness of the system in which they operate.

The Identity Management 240A component is responsible for managing user identities and roles, playing a role in ensuring secure access and policy enforcement within the system. In some embodiments, Identity Management 240A may integrate with external identity providers to enhance its capabilities. For example, in some embodiments, Identity Management 240A may be implemented using Azure Active Directory (AAD), which provides a comprehensive framework for handling authentication and authorization processes.

Also for example, Identity Management 240A may be implemented as a cloud-based identity and access management service that offers robust security features, including multi-factor authentication, conditional access policies, and identity protection. In these embodiments, Identity Management 240A can leverage these features to manage user identities and roles effectively, ensuring that only authorized users have access to specific APIs and services.

In various embodiments described herein, Identity Management 240A facilitates the automatic registration of provider and consumer applications, assigning default roles and permissions based on predefined policies. This integration ensures that authentication and authorization protocols are standardized and consistent, reducing the risk of unauthorized access and enhancing overall security.

The interactions between these components in FIG. 2A are depicted with arrows indicating the flow of information. In summary, at 212A, the API Provider creates an API, which is communicated to the API Gateway. At 214A, a policy is created for the API. The Onboarding Service then registers the provider application with the Identity Management system at 222A. The Identity Management system creates the provider application at 242A and returns an application ID at 244A. This application ID is then used to update the policy at 224A.

At 212A, the API Provider initiates the creation of an API, which involves defining the API's parameters and associated security policies. In some embodiments, this process is automated to streamline the onboarding of APIs, reducing manual intervention and potential errors. The API creation process may include specifying the API's functionality, endpoints, data formats, and security requirements. In some embodiments, the API Provider uses a web-based portal or software application to input these details, ensuring that the API is configured to meet specific service needs and security standards.

For example, in the case of an SMS API, the API parameters might include message format (such as plain text or multimedia), delivery options (such as immediate or scheduled delivery), and supported protocols (such as SMPP or HTTP). Security requirements might specify encryption standards for message content and authentication methods for API access.

Following the creation of the API, at 214A, a policy is generated for the API. In some embodiments, this policy might be specified by the API Provider, or it may be automatically generated by the system. The policy combines authentication and authorization rules, defining how access to the API is controlled and monitored. It may also include default settings that can be overridden based on roles. For example, an organization may specify a default set of parameter values, such as different tiers of use for the SMS API, where basic users have limited message throughput and premium users have higher limits. In some embodiments, users may override these defaults when creating the policy, allowing for customized access levels.

In some embodiments, the policy may include the generation of a token such as a JSON Web Token (JWT), which encapsulates authentication and authorization information in a single token, providing a secure and efficient mechanism for managing access. In various embodiments, the creation of the API and its policy is integrated with Identity Management 240A, ensuring that the API and its policies are registered and managed within a robust identity management framework, allowing for dynamic role assignment and policy adjustments based on predefined rules and usage patterns. By automating these processes, the system provides a seamless and efficient API management experience, enhancing security and operational efficiency across diverse deployment scenarios.

The API Gateway 150 requests the Onboarding Service initiate the registration of the provider application at 222A, and the Onboarding Service requests the Identity Management 240A create register the provider application at 232A. This establishes the provider application's presence within the identity management framework, allowing for subsequent authentication and authorization processes. In some embodiments, the registration process is automated, reducing manual intervention and potential errors. The Onboarding Service interfaces with the identity management system to create application entries, assign necessary permissions, and generate application IDs. This automation ensures that the provider application is seamlessly integrated into the identity management system, facilitating efficient management of user identities and roles.

At 242A, the identity management system completes the registration of the provider application. This involves creating the provider application within the system and assigning it a unique application ID. The application ID serves as a reference for the identity management system to track and manage the provider application's interactions and access permissions. In some embodiments, the identity management system may leverage external identity providers to enhance its capabilities. By integrating with these platforms, the identity management system can offer robust security features, including multi-factor authentication and conditional access policies, ensuring that the provider application is securely registered and managed.

At 244A, the identity management system 240A sends the application ID to the Onboarding service 230A. The application ID serves as a unique identifier for the provider application within the identity management framework. The application ID is generated by the identity management system 240A upon successful registration of the provider application, and it is used to track and manage the application's interactions and access permissions.

Similarly, at 234A, the application ID is communicated from the Onboarding service 230A to the API Gateway 156. This ensures that the API Gateway has the necessary information to associate the provider application with its corresponding security policies and access controls.

Once the API Gateway 156 receives the application ID, it updates the API's policy at 224A to include this identifier. The application ID is used to facilitate secure access and management of the API by linking the provider application to its authentication and authorization policies. This linkage allows the API Gateway to enforce access controls based on the roles and permissions defined within the identity management system. By having the application ID, the API Gateway can efficiently manage API requests, ensuring that only authorized applications can access the API, thereby enhancing security and operational efficiency.

FIG. 2B is a block diagram illustrating an example, non-limiting embodiment of an API consumer registration flow in accordance with various aspects described herein. FIG. 2B illustrates interactions between various systems during a consumer registration process. For example, interactions are shown between API Consumer 210B, Consumer Portal 220B, Dynamic Client Registration (DCR) 230B, Onboarding Service 230A, and Identity Management 240A. The flow diagram shows the interactions and communications between these components during the registration process.

In the context of the API consumer registration process, the API consumer 210B can be an individual user, a business entity, or a software application that requires access to an API to perform specific functions. The consumer might be a developer or a company seeking to integrate external services into their own applications or systems. For example, in the case of an SMS API, the consumer could be a business that uses a messaging application to send automated text notifications, marketing messages, or alerts to its customers. This business might utilize the API to enhance its communication strategies, improve customer engagement, and streamline operations by automating message delivery. The API consumer could also be a third-party application that leverages the API to offer additional features or services to its users, such as integrating SMS capabilities into a customer relationship management (CRM) platform or a customer support system. In all these scenarios, the consumer interacts with the API to access the desired functionalities, relying on the API's capabilities to meet their specific needs and objectives.

At 212B, the API consumer initiates the consumer registration process by accessing the Consumer Portal 220B. This step marks the beginning of the consumer's journey to integrate with the API and gain access to its functionalities. The Consumer Portal serves as the interface through which the consumer can create a new consumer application, providing the necessary details and configurations required for registration. In some embodiments, the portal may offer a user-friendly interface that guides the consumer through the setup process, allowing them to specify application parameters such as the intended use, access requirements, and security preferences. For example, in the context of an SMS API, the consumer might define the types of messages they plan to send, the volume of messages, and any specific delivery options they require. By initiating the registration process at block 212B, the consumer sets the stage for subsequent steps that involve authentication, authorization, and role assignment, ultimately enabling them to leverage the API's capabilities to meet their specific needs.

In the first part of the process, denoted as 270B, the API consumer creates a consumer application for the first time. At Create Consumer App 212B, the consumer application is created, and the process moves to Register Consumer App 222B, where the application is registered with Dynamic Client Registration (DCR) 230B. A consumer application might be a software application or service that requires access to an API to perform specific functions. For example, in the context of an SMS API, a consumer application could be a messaging app that allows businesses to send automated text notifications, marketing messages, or alerts to customers.

Dynamic Client Registration (DCR) 230B is a component that interfaces with the onboarding service and identity management system to register consumer applications, ensuring that they are properly configured with the necessary permissions and roles. This integration allows for the efficient management of user identities and access controls, enhancing security and operational efficiency. For example, in the context of an SMS API, DCR 230B might automatically assign appropriate access levels based on predefined policies, such as message throughput limits or delivery options, tailored to the consumer's specific requirements.

By leveraging DCR, the system can adapt to changing conditions and user behaviors, dynamically adjusting access permissions and roles as needed. This flexibility ensures that API consumers can quickly and securely access the services they need, while maintaining robust security measures to protect sensitive data and resources.

Identity Management 240A generates the client ID and secret as part of the consumer application registration process, providing credentials for authenticating and authorizing API access. The client ID is a unique identifier assigned to each consumer application, ensuring that each application can be distinctly recognized within the identity management framework. This uniqueness allows for tracking and managing interactions and access permissions associated with each consumer application.

The secret, akin to a password, is generated alongside the client ID to enhance security during the authentication process. It serves as a confidential key that, when combined with the client ID, verifies the identity of the consumer application requesting access to the API. The secret is designed to be securely stored and transmitted, ensuring that only authorized applications can access the API.

In some embodiments, Identity Management 240A leverages advanced security protocols and algorithms to generate these credentials, ensuring their robustness and integrity. The generation process may involve cryptographic techniques to create strong, unpredictable secrets that are resistant to unauthorized access attempts. By providing unique client IDs and secure secrets, Identity Management 240A plays a role in maintaining the security and reliability of API interactions. At 228B, 232B, and 234B, the client ID and secret generated by Identity Management 240A are provided to the Consumer Portal 220B.

In the second part of the process, denoted as 280B, the API consumer registers the application created at 270B. The process continues with Register Consumer App 242B, where the consumer application is further registered with Onboarding Service 230A. Onboarding Service 230A then requests Identity Management 240A to register the consumer application at 244B. Identity Management 240A completes the registration process and assigns a default role to the consumer application at block 246B. This default role defines the initial access level and permissions for the consumer application within the API framework. The default role, along with the client ID and secret, is then provided to the Consumer Portal 220B at blocks 248B and 250B, ensuring that the consumer application is equipped with the necessary credentials and access rights to interact securely with the API. This comprehensive process facilitates a seamless and secure onboarding experience for API consumers, enabling them to access the desired functionalities with confidence in the security and integrity of their interactions.

FIG. 2C is a block diagram illustrating an example, non-limiting embodiment of an API consumer runtime flow in accordance with various aspects described herein. FIG. 2C shows interactions between API consumer 210B, Identity Management 240A, API gateway 156 and Service API 260C.

The Service API 260C plays a role in the consumer runtime flow, serving as the endpoint that provides the desired functionalities to the API consumer. The Service API 260C is responsible for processing requests from the consumer and delivering the appropriate resources or services. The Service API 260C interacts with the API Gateway 156 to ensure that all incoming requests are properly authenticated and authorized before any resources are accessed. This interaction maintains the security and integrity of the system, as it prevents unauthorized access to sensitive data or services. The Service API 260C can be implemented using various technologies, such as RESTful or GraphQL APIs, depending on the specific requirements and architecture of the system. The design of the Service API 260C allows for scalability and efficiency, enabling the handling of a large number of requests from multiple consumers simultaneously.

The Token Renewal Process 220C is a mechanism that ensures the ongoing validity of access tokens used by API consumers. This process is responsible for renewing tokens before they expire, thereby maintaining uninterrupted access to the API services. The Token Renewal Process 220C interacts with the Identity Management 240A to generate new tokens based on the existing credentials and policies. This process can be configured to renew tokens at regular intervals, such as once every 60 minutes, to ensure that the consumer's access remains valid without requiring frequent re-authentication. The renewal process enhances the user experience by reducing the need for manual intervention and minimizing disruptions in service access. The process also contributes to maintaining security by ensuring that tokens are regularly updated and any potential vulnerabilities associated with long-lived tokens are mitigated.

The Access Token Request 222C represents the initial step in the process of obtaining an access token for API usage. This request is made by the API consumer and includes credentials such as the client ID, secret, and scope of access. The Access Token Request 222C is sent to the Identity Management 240A, which verifies the provided credentials and determines the appropriate level of access based on the defined policies. This request establishes the consumer's identity and the permissions they are granted. The implementation of the Access Token Request 222C can vary depending on the authentication protocol used, such as OAuth 2.0, which is commonly employed for secure token-based authentication.

The Access Token Response 224C is the subsequent step following the Access Token Request 222C, where the Identity Management 240A provides the API consumer with an access token. This response confirms that the consumer's credentials have been successfully validated and that they are authorized to access the specified resources. The Access Token Response 224C includes the access token itself, which the consumer will use in subsequent requests to the API Gateway 156. This token serves as proof of the consumer's identity and permissions, allowing them to interact with the Service API 260C securely. The response may also include additional information, such as the token's expiration time and any refresh tokens that can be used for renewing the access token.

The Resource Request 232C is the action taken by the API consumer to access specific resources or services provided by the Service API 260C. This request includes the access token obtained from the Access Token Response 224C, which is used to authenticate the consumer's identity and verify their permissions. The Resource Request 232C is sent to the API Gateway 156, which acts as an intermediary, forwarding the request to the Service API 260C after validating the token. This step is ensures that only authorized consumers can access the resources, maintaining the security and integrity of the system. The Resource Request 232C can be implemented using various HTTP methods, such as GET, POST, PUT, or DELETE, depending on the type of interaction required with the Service API 260C.

The Token Validation 234C provides a security measure performed by the API Gateway 156 to verify that the access token provided in the Resource Request 232C is valid and has not been tampered with. This validation process involves checking the token's signature, expiration time, and any associated claims to confirm the authenticity of the token and that the consumer has the appropriate permissions to access the requested resources. The Token Validation 234C plays a role in preventing unauthorized access and ensuring that the system's security policies are consistently enforced. This process can be implemented using various cryptographic techniques, such as verifying the token's signature with a public key, to maintain the integrity and authenticity of the token.

The Resource Request 236C is the subsequent step following the successful Token Validation 234C, where the API Gateway 156 forwards the validated request to the Service API 260C. This request includes the necessary information for the Service API 260C to process and deliver the requested resources to the consumer. The Resource Request 236C enables the consumer to interact with the Service API 260C and access the desired functionalities. This step is designed to be efficient and secure, ensuring that the consumer's requests are processed promptly and that the system's resources are protected from unauthorized access.

The Resource 238C represents the actual data or service provided by the Service API 260C in response to the Resource Request 236C. This component is the end result of the consumer's interaction with the API, delivering the requested information or functionality to the consumer. The Resource 238C can take various forms, such as JSON or XML data, depending on the API's design and the consumer's requirements. This component is designed to be flexible and scalable, capable of delivering a wide range of services to meet the diverse needs of API consumers. The Resource 238C plays an important role in the consumer runtime flow, as it provides the tangible benefits and functionalities that the consumer seeks from the API.

The Resource 242C represents the final step in the consumer runtime flow, where the Service API 260C delivers the requested resource back to the API Gateway 156, which then forwards the resource to the API consumer. This step completes the interaction between the consumer and the API, providing the consumer with the data or service they requested.

FIG. 2D is a flowchart illustrating an example, non-limiting embodiment of a method for registering an API provider, in accordance with various aspects described herein. This method may be performed by components such as the API Gateway 156, Onboarding Service 230A, and Identity Management 240A, as depicted in previous figures.

At block 210D, the method begins with receiving an API definition and a security policy from an API provider. In some embodiments, this action involves the API Gateway 156 receiving detailed specifications of the API, including its endpoints, data formats, and security requirements. For example, the API provider might submit these details through a web-based portal, ensuring that the API is configured to meet specific service needs and security standards.

At block 220D, the API definition is registered with an identity management system. This step may involve the Onboarding Service 230A interfacing with Identity Management 240A to create an entry for the API within the identity management framework. In some embodiments, this registration process is automated, reducing manual intervention and potential errors. For example, the Onboarding Service might automatically generate application entries and assign necessary permissions.

At block 230D, a registration response is received from the identity management system. This response typically includes an application ID, which serves as a unique identifier for the API within the identity management system. In some embodiments, the application ID is used to track and manage the API's interactions and access permissions, ensuring that it is securely registered and managed.

At block 240D, a token-based authentication and authorization policy is generated in response to the API definition, the security policy, and the registration response. This policy combines authentication and authorization rules, defining how access to the API is controlled and monitored. In some embodiments, the policy may include the generation of a JSON Web Token (JWT), which encapsulates authentication and authorization information in a single token, providing a secure and efficient mechanism for managing access.

FIG. 2E is a flowchart illustrating an example, non-limiting embodiment of a method for API consumer registration, in accordance with various aspects described herein. This method may be performed by components such as the Consumer Portal 220B, Dynamic Client Registration (DCR) 230B, and Identity Management 240A, as depicted in previous figures.

At block 210E, the process begins with receiving a client registration request from an API consumer, where the client registration request is requesting access to an API. In some embodiments, this action involves the Consumer Portal 220B receiving the request, which includes necessary details about the consumer application. For example, the API consumer might submit this request through a web-based interface, specifying the intended use and access requirements for the API.

At block 220E, the consumer is registered with the identity management system. This step may involve Dynamic Client Registration (DCR) 230B interfacing with Identity Management 240A to create an entry for the consumer application within the identity management framework. In some embodiments, this registration process is automated, reducing manual intervention and potential errors. For example, DCR might automatically generate client credentials and assign necessary permissions.

At block 230E, client credentials are received from the identity management system. These credentials typically include a client ID and a secret, which are used to authenticate the consumer application. In some embodiments, the client ID serves as a unique identifier for the consumer application, while the secret functions similarly to a password, providing an additional layer of security.

At block 240E, the client credentials are provided to the API consumer. This step ensures that the consumer application is equipped with the necessary credentials to authenticate and authorize API access. In some embodiments, the credentials are securely transmitted to the API consumer through the Consumer Portal 220B, facilitating a seamless and secure onboarding experience.

FIG. 2F is a flowchart illustrating an example, non-limiting embodiment of a method for the API consumer runtime flow, in accordance with various aspects described herein. This method may be performed by components such as the API Gateway 156, Identity Management 240A, and Service API 260C, as depicted in previous figures.

At block 210F, the process begins with receiving an access request from an API consumer, including client credentials. In some embodiments, this action involves the API Gateway 156 receiving the request, which contains the client ID and secret previously provided to the consumer application. For example, the API consumer might submit this request to access specific resources or services offered by the Service API 260C.

At block 220F, the client credentials received from the API consumer are validated to create validated credentials. This step may involve the API Gateway 156 interfacing with Identity Management 240A to verify the authenticity of the credentials. In some embodiments, this validation process includes checking the credentials against stored records to ensure they are correct and have not been tampered with. For example, the system might use cryptographic techniques to validate the credentials securely.

At block 230F, access control for the API is enforced based on the validated credentials. This involves the API Gateway 156 ensuring that the consumer application has the appropriate permissions to access the requested resources. In some embodiments, this enforcement includes applying role-based access controls and checking against predefined security policies. For example, the system might limit access to certain API endpoints based on the consumer's assigned role or usage patterns.

While for purposes of simplicity of explanation, the respective processes are shown and described as a series of blocks in FIGS. 2D-2F, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

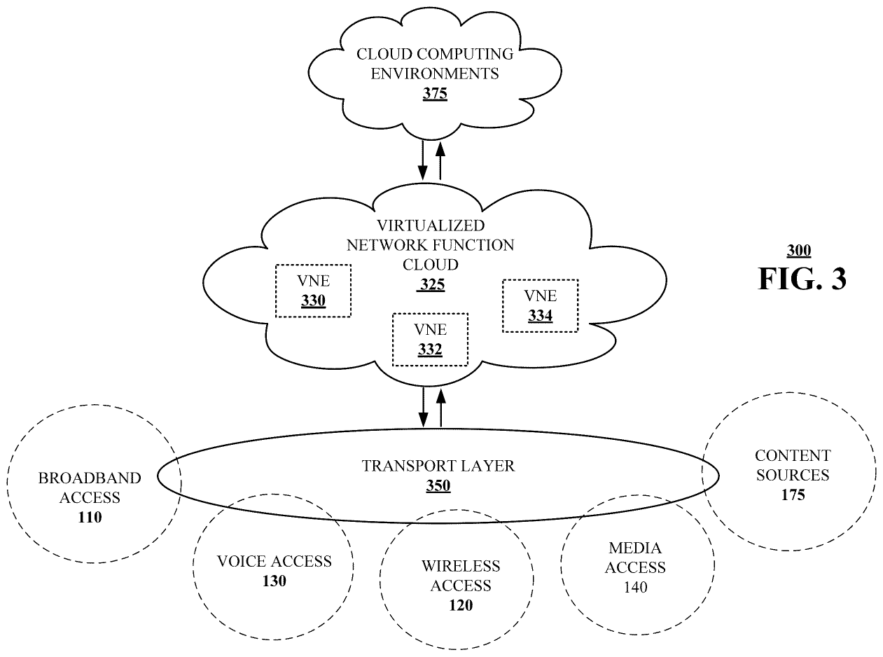

Referring now to FIG. 3, a block diagram 300 is shown illustrating an example, non-limiting embodiment of a virtualized communication network in accordance with various aspects described herein. In particular a virtualized communication network is presented that can be used to implement some or all of the systems, subsystems, and functions described herein. For example, virtualized communication network 300 can facilitate in whole or in part an automated system that manages API access and policy enforcement, integrating authentication and authorization processes with identity management to streamline service exposure and secure data exchange between API providers and consumers.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements-which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers-each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

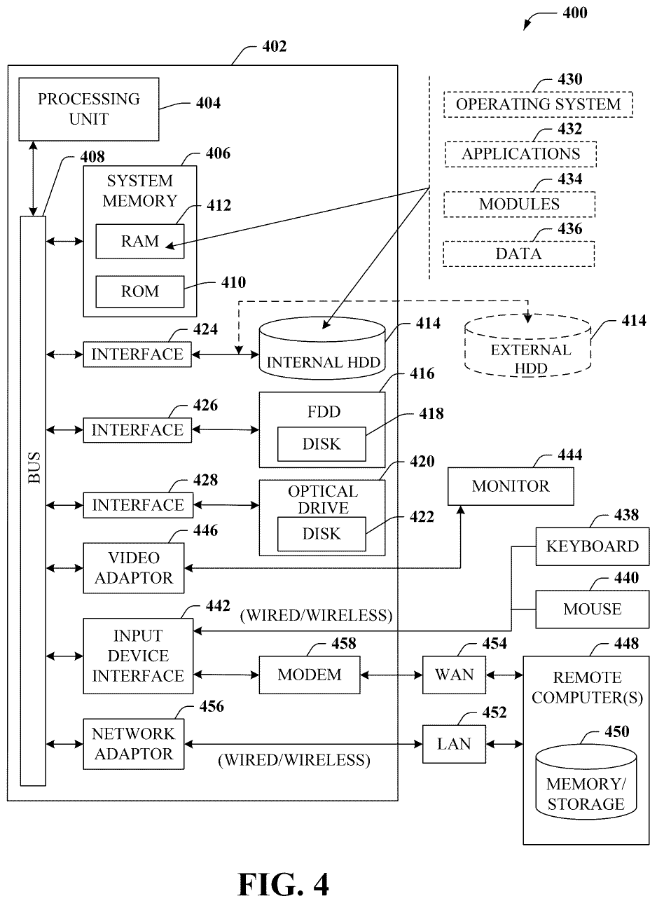

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part an automated system that manages API access and policy enforcement, integrating authentication and authorization processes with identity management to streamline service exposure and secure data exchange between API providers and consumers.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

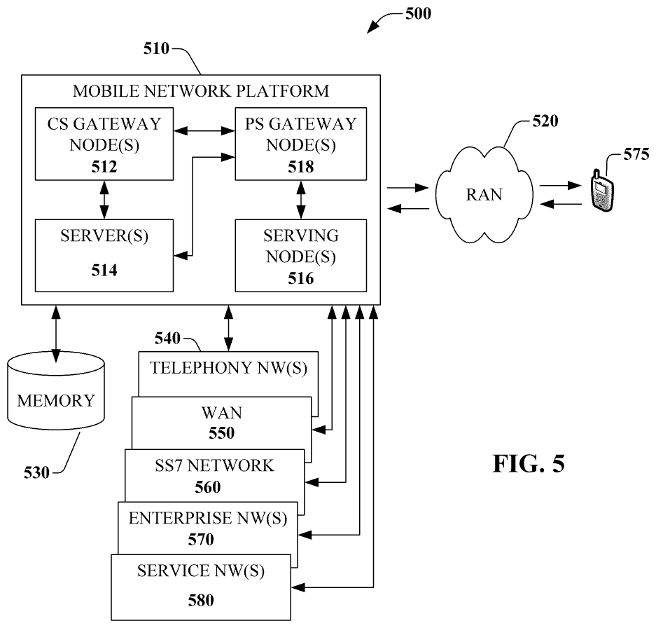

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part an automated system that manages API access and policy enforcement, integrating authentication and authorization processes with identity management to streamline service exposure and secure data exchange between API providers and consumers. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

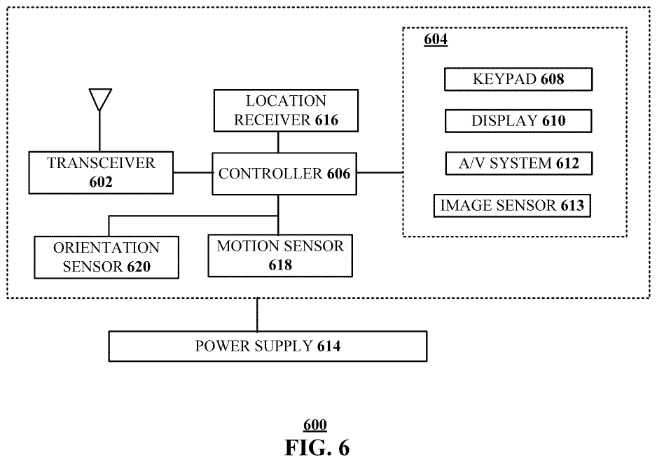

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part an automated system that manages API access and policy enforcement, integrating authentication and authorization processes with identity management to streamline service exposure and secure data exchange between API providers and consumers.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” “data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” “subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” “data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
receiving an API definition and a security policy from equipment of an API provider;
creating an API within an API gateway based on the received API definition;
generating a policy for the API that combines authentication and authorization based on the security policy;
registering an API provider application with an identity management system;
receiving an application ID from the identity management system in response to the registering;
updating the policy for the API with the application ID resulting in an updated policy; and
storing the updated policy to be accessible by the API gateway to facilitate secure access and management of the API.

2. The device of claim 1, wherein the operations further comprise automatically generating a JSON Web Token (JWT) as part of the authentication and authorization policy for the API.

3. The device of claim 1, wherein the identity management system is integrated with Azure Active Directory (AAD) to facilitate the management of user identities and roles.

4. The device of claim 1, wherein the operations further comprise providing an option for the API provider to manually approve or automatically approve API consumer access requests.

5. The device of claim 1, wherein the operations further comprise implementing rate limiting and monitoring of API usage to prevent unauthorized access and ensure compliance with the security policy.

6. The device of claim 1, wherein the operations further comprise dynamically adjusting access permissions based on predefined rules and usage patterns.

7. A non-transitory machine-readable medium, comprising executable instructions that, when executed by a processing system including a processor, facilitate performance of operations, the operations comprising:
receiving a client registration request from equipment of an API consumer, the client registration request requesting access to an API;
registering the API consumer with an identity management system;
receiving client credentials from the identity management system;
providing the client credentials to the equipment of the API consumer;
receiving an access request from the equipment of the API consumer including the client credentials;
validating the client credentials received from the equipment of the API consumer to create validated credentials;
and enforcing access control for the API based on the validated credentials.

8. The non-transitory machine-readable medium of claim 7, wherein the operations further comprise generating a token for the API consumer upon successful validation of the client credentials, the token being used for subsequent access requests.

9. The non-transitory machine-readable medium of claim 8, wherein the operations further comprise renewing the token for the API consumer at predefined intervals.

10. The non-transitory machine-readable medium of claim 8, wherein the operations further comprise validating the token received from the API consumer during runtime.

11. The non-transitory machine-readable medium of claim 7, wherein the operations further comprise providing the API consumer with a default role upon registration, which determines a level of access to the API.

12. The non-transitory machine-readable medium of claim 7, wherein the operations further comprise dynamically adjusting access permissions of the API consumer based on usage patterns and predefined security policies.

13. A method, comprising:
receiving, by a processing system including a processor, a definition for an application programming interface (API) and a security policy from an API provider;
registering, by the processing system, the definition for the API with an identity management system;
receiving, by the processing system, a registration response from the identity management system;
generating, by the processing system, a token-based authentication and authorization policy in response to the definition for the API, the security policy, and the registration response;
receiving, by the processing system, a client registration request from equipment of an API consumer, wherein the client registration request requests access to the API;
registering, by the processing system, the API consumer with the identity management system;
receiving, by the processing system, client credentials from the identity management system;
providing, by the processing system, the client credentials to the equipment of the API consumer;
receiving, by the processing system, an access request from the equipment of the API consumer including the client credentials;
validating, by the processing system, the client credentials received from the equipment of the API consumer to create validated credentials; and
enforcing, by the processing system, access control for the API based on the validated credentials.

14. The method of claim 13, wherein the token-based authentication and authorization policy includes a JSON Web Token (JWT) that encapsulates the authentication and authorization information for the API consumer.

15. The method of claim 13, further comprising assigning, by the processing system, a default role to the API consumer upon registration with the identity management system.

16. The method of claim 13, wherein the client credentials include a client ID and a client secret, which are used to authenticate the API consumer.

17. The method of claim 13, further comprising updating, by the processing system, the security policy based on predefined rules and usage patterns to dynamically adjust access permissions.

18. The method of claim 13, wherein the identity management system is implemented in a cloud infrastructure.

19. The method of claim 13, further comprising providing, by the processing system, an option for the API provider to automatically approve the access request.

20. The method of claim 13, wherein the enforcing includes rate limiting and monitoring of API usage to prevent unauthorized access and ensure compliance with the security policy.
